(19) United States
(12) Patent Application Publication
(10) Pub. No.: US 2008/0084089 A1
(43) Pub. Date: Apr. 10, 2008

(54) Telescoping recreational vehicle lift system

(76) Inventor: Christopher H. Hanson, Albany, OR (US)

Correspondence Address: Teri G. Andrews;Attorney at Law, 1717 NW Grant Ave., Corvallis, OR, 97330, US

(21) Appl. No.: 11/973,163

(22) Filed: Oct. 4, 2007

Related U.S. Application Data
(60) Provisional application No. 60/849,592, filed on Oct. 4, 2006.

(51) Int. Cl. B60P 3/355; B66F 7/20

(52) U.S. Cl. 296/171; 254/45

(57) ABSTRACT

There is a telescoping camper that has a lower camper portion and an upper camper portion that slides around and over the lower camper portion in a telescoping fashion. Primary jacks are attached to each corner of the upper camper portion. There is a lift mechanism attached to the upper edge of each primary jack that actuates a jack extension that extends and contracts from the bottom edge of each primary jack. There is a removable jack support attached to each corner of the lower camper portion and adjacent to and essentially parallel to each primary jack. Each jack support has a support platform attached to the base. The upper camper portion is telescoped upward from the lower camper portion by actuating the lift mechanism that extends all four jack extensions simultaneously with the jack bases contacting and pushing upward from the support platforms until the upper camper portion is in a fully extended position. The over cab portion of the camper has collapsible front and side walls that are automatically erected by a system of cables that attach between the collapsible walls and the upper camper portion as the upper camper portion is raised upward. Using the same lift mechanism and jack system, with the jack supports removed, the jack extensions are lowered to the ground and the telescoping camper is lifted from the truck bed for removal.

### CROSS-REFERENCE TO RELATED APPLICATIONS

This application claims priority under 35 U.S.C. §119(e) to U.S. Provisional Application Ser. No. 60/849,592 entitled “Telescoping RV Lift System” filed on Oct. 4, 2006, by the present inventor, Christopher H. Hanson, the entire disclosure of which is herein incorporated by reference for all purposes.

### BACKGROUND OF THE INVENTION

1. Field of the Invention

The present invention relates to recreational vehicles, and more particularly to recreational vehicles that have a telescoping body which can be lowered for streamlined travel and raised to provide additional overhead space when occupied.

2. Prior Art

Many types of recreational trailers and campers are known. Recreational trailers are popularly used for camping or other recreational purposes. Particularly popular are the fold-down or telescoping campers which, when erected, provide ample living space for several persons. When not in use, the fold-down or telescoping camper collapses to a much small volume for easy transport and storage.

Telescoping truck campers and travel trailers have been on the market for some time. These campers and trailers require some means of raising and lowering the upper or extendable portion of the camper or trailer. They have been produced using a variety of lift systems. Most of these lift systems include motors or hydraulic systems that drive a variety of cables, springs, jacks or other levers and arms to raise and lower the upper roof section. Some of these lifts systems are interior to the trailer while others are attached to the outside of the trailer.

Truck campers typically have external jacks that are used to raise the camper off the bed of the truck for camper removal. With the currently available telescoping campers, a secondary lift system or set of jacks are required to raise and lower the upper roof and wall assemblies. Consequently, two lift systems are required in order extend the telescoping camper and to lift the camper for removal and loading.

U.S. Pat. No. 7,090,286 issued to Foreth et al. discloses a typical telescoping camper that has a rigid lower body section with a telescoping rigid roof where the roof is connected to the lower section with a canvas type material. The upper roof section is raised by a lift assembly consisting of a metal structure that is driven upward by an electric motor driving a screw feed device. This is a complicated structure that consumes interior space within the camper, detracts from the interior aesthetics of the camper, and requires a lift system in addition to the camper removal/leveling lift system.

There is yet another type of telescoping camper available that has a fully (non-canvas) rigid upper and lower section. This camper uses a secondary, internally mounted, hydraulic system of pump motors and pistons to raise the upper roof section. The over the truck cab folding walls are manually raised after the roof section is raised via the hydraulic pumps, and then latched into place. This camper also employs two lift systems—one for the telescoping of the camper and one for removing the camper from the truck.

The currently available telescoping campers have improved camper portability by allowing the camper to be lower and less wind resistant during transport as well as minimizing the camper size for storage. Unfortunately, these systems require a dedicated lift system that is, in the majority of cases, internal to the camper taking up valuable space, quite complicated, and expensive to manufacture.

There is a need for a telescoping camper that is easy to use, has rigid walls throughout, is aesthetically pleasing and simplistic in design minimizing the cost of manufacturing and need for maintenance.

3. Objects and Advantages

It is a primary objective of the present invention to provide a telescoping camper, travel trailer, fifth wheel trailer, or similar types of recreational vehicles that utilizes a single jacking or lift system for raising and lowering the upper section or roof of the telescoping unit and for lifting the camper or trailer off the ground or truck when not in use.

It is another object of the present invention to provide a telescoping camper or travel trailer that has rigid folding walls in the upper telescoping portion that are raised automatically by the aforementioned single jacking system when the upper roof telescoping portion is extended upward. These rigid folding walls also collapse automatically when the upper roof telescoping portion is collapsed.

It is yet another object of the present invention to provide a telescoping camper or travel trailer that does not compromise the aesthetics of the camper or travel trailer with unsightly lifting mechanisms and structures either inside or outside of the camper or trailer.

It is a further object of the present invention to provide a telescoping camper or travel trailer that is economical to produce, and easy to use.

### SUMMARY OF THE INVENTION

The present invention discloses a telescoping camper that has a lower camper portion and an upper camper portion that slides around and over the lower camper portion in a telescoping fashion. Primary jacks are attached to each corner of the upper camper portion. There is a lift mechanism attached to the upper edge of each primary jack that actuates a jack extension that extends and contracts from the bottom edge of each primary jack. There is a removable jack support attached to each corner of the lower camper portion and adjacent to and essentially parallel to each primary jack. Each jack support has a support platform attached to the base. The upper camper portion is telescoped upward from the lower camper portion by actuating the lift mechanism that extends all four jack extensions simultaneously with the jack bases contacting and pushing upward from the support platforms until the upper camper portion is in a fully extended position. The over cab portion of the camper has collapsible front and side walls that are automatically erected by a system of cables that attach between the collapsible walls and the upper camper portion as the upper camper portion is raised upward. Using the same lift mechanism and jack system, with the jack supports removed, the jack extensions are lowered to the ground and the telescoping camper is lifted from the truck bed for removal.

### BRIEF DESCRIPTION OF THE DRAWINGS

The above description and other objects, advantages, and features of the present invention will be more fully understood and appreciated by reference to the specification and accompanying drawings, wherein:

FIG. 1 is a perspective view of the preferred embodiment of the telescoping camper of the present invention mounted on the bed of a pickup and in the fully extended position.

FIG. 2A through FIG. 2D is a series of perspective views of the preferred embodiment of the present invention illustrating the telescoping of the camper from the fully collapsed position to the fully extended position.

FIG. 3 is a perspective view of the preferred embodiment of the present invention depicting the camper removed from the truck, collapsed, and ready for storage.

FIG. 4 is a detailed view of the jacking system of the preferred embodiment of the present invention.

FIG. 5A through FIG. 5C is a series of perspective views of the folding walls of the present invention from the interior of the telescoping camper.

### DRAWINGS REFERENCE NUMBERS

| | |
|---|---|
| 100 | Telescoping Camper |
| 102 | Truck |
| 104 | Camper Top Portion |
| 106 | Camper Lower Portion |
| 108 | Folding Front Wall |
| 110 | Folding Side Wall |
| 112 | Lift Mechanism |
| 114 | Camper Window |
| 118 | Primary Jack |
| 119 | Jack Extention |
| 120 | Jack Support |
| 122 | Support Platform |
| 124 | Support Attach Plate |
| 202 | Security Pins |
| 204 | Jack Base |
| 206 | Camper Base |
| 424 | Support Attachment Plate |
| 426 | Jack Support Pin |
| 506 | Collapsible Wall Hinge |
| 508 | Wall Latch |
| 509 | Latch Catch |
| 510 | Hinge Cover |
| 512 | Side Wall Cables |
| 514 | Front Wall Cables |

### DETAILED DISCUSSION OF THE PREFERRED EMBODIMENTS

Referring to the figures, like elements retain their indicators throughout the several views.

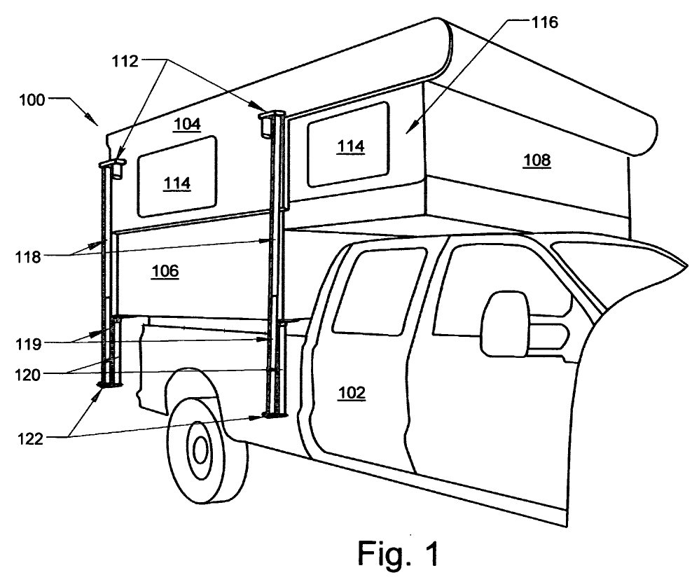

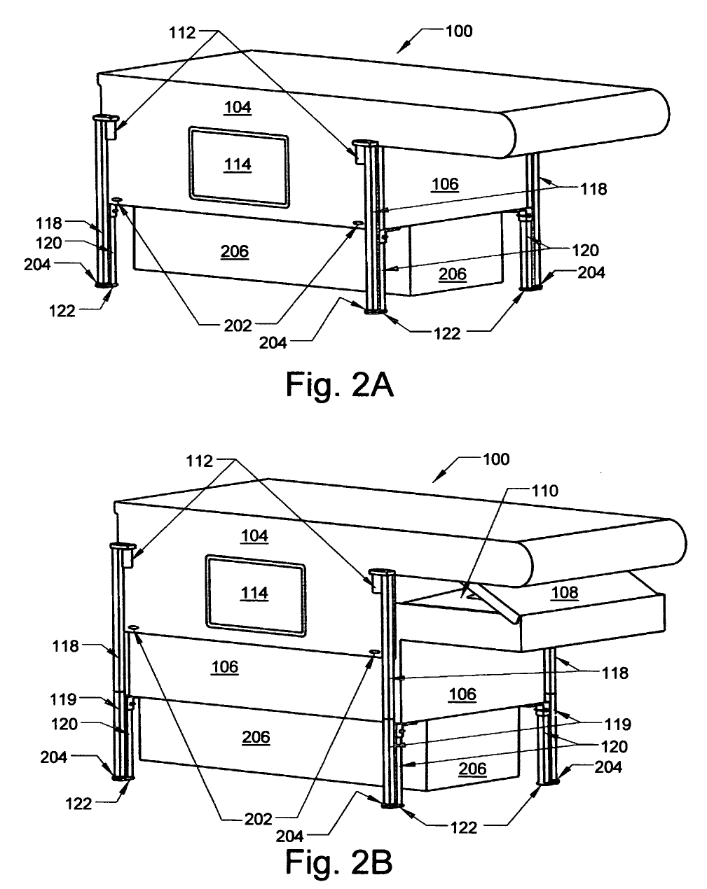

FIG. 1 is a perspective view of the preferred embodiment of Telescoping Camper 100 of the present invention mounted on the bed of Pickup 102 and in a fully extended position. Telescoping Camper 100 is made in two sections—Camper Upper Portion 104 and Camper Lower Portion 106. For travel and storage, Camper Upper Portion 104 is lowered over over Camper Lower Portion 106. During the lowering process, Folding Side Wall 110 folds down and interior to Telescoping Camper 100 as does Folding Front Wall 108 (discussed in detail with FIG. 2).

Although the preferred embodiment of the present invention is depicted as a truck camper, alternate embodiments would include other recreational vehicles such as travel trailers, fifth wheel trailers and the like.

As shown in FIG. 1, Telescoping Camper 100 in this raised position looks very much like any other cab over type camper. In this preferred embodiment, Telescoping Camper 100 has two Windows 114—one disposed on the side of Camper Upper Portion 104 and the other on Folding Side Wall 100. Folding Side Wall 110 is attached along the width of the base with a hinge (not shown) to the side Camper Lower Portion 106. Similarly, Folding Front Wall 108 is attached along the width of the base with a hinge (not shown) to the front of Camper Lower Portion 106.

Primary Jacks 118 are attached at each of the four corners of Camper Upper Portion 104 of Telescoping Camper 100. Primary Jacks 118 each have a Jack Extension 118 that protrudes from the base of Primary Jack 118 when lifting Telescoping Camper 100. Jack Support 120 is attached to each of the four corners of Camper Lower Portion 106 and each has Support Platform 122 which each Jack Extension 119 contacts and pushes against to raise or telescope Telescoping Camper 100. Shown at the top of each Primary Jack 118 is Lift Mechanism 112 which powers the extension and contraction of Jack Extensions 119. In the preferred embodiment, Lift Mechanism 112 is an electric motor (not shown) which drives a jack screw (not shown) that extends Jack Extension 119. It has been contemplated by the inventor to have Lift Mechanism 112 also be a ball screw, lead screw, hydraulic cylinder, pneumatic cylinder or other suitable means to extend and contract Jack Extension 119. All of the aforementioned lift mechanisms can be manually driven or electrically driven. In the preferred embodiment, Lift Mechanism 112 is actuated by a handheld controller (not shown) that is stored in a rear storage compartment of Telescoping Camper 100. Additionally, in the preferred embodiment Lift Mechanism 112 has travel limit switches that act as safety stops (not shown) at both full extension and full contraction. These travel limit switches protect against inadvertent over extension or contraction.

FIG. 2A through FIG. 2D is a series of perspective views of the preferred embodiment of the present invention illustrating the raising or telescoping of Telescoping Camper 100 from the fully collapsed position to the fully extended position. For clarity, Truck 102 has been removed from these figures.

In FIG. 2A, Telescoping Camper 100 is in the fully collapsed position. Camper Base 206 is the portion of Telescoping Camper 100 that rests in the bed of the truck and is attached to Camper Lower Portion 106. Camper Top Portion 104 is lowered over Camper Lower Portion 106. Camper Top Portion 104 and Camper Bottom Portion 106 are latched together by Security Pins 202 when in the fully collapsed position.

FIG. 2B illustrates the raising of Telescoping Camper 100. Two Security Pins 202 are located on either side of Telescoping Camper 100 and must be removed for raising Camper Upper Portion 104. As Jack Base 204 of Jack Extension 118 begins to push against Support Platform 122 of Jack Support 120, Camper Upper Portion 104 begins telescoping upward.

The upper edge of Folding Front Wall 108 has a pair of cables (not shown) attached to Camper Upper Portion 104 while the base is attached to Camper Lower Portion 106 with a length of hinge (not shown). Similarly, Folding Side Wall 110 has a pair of cables (not shown) attached to Camper Upper Portion 104 and it is also attached to Camper Lower Portion 106 with a length of hinge (not shown) at the base. As Camper Upper Portion 104 begins to rise, the cables (not shown) pull the upper edge of Folding Front Wall 108 and Folding Side Walls 110 thereby pivoting the walls toward a more vertical position. Folding Front Wall 108 begins rising first with Folding Side Walls 110 following.

FIG. 2C shows Folding Front Wall 108 nearly vertical with Folding Side Wall 110 approximately half way.

FIG. 2D shows Telescoping Camper 100 fully extended with Folding Front Wall 108 and Folding Side Wall 110 essentially vertical. For stability, Security Pins 202 can be locked into place. Additionally, Folding Side Walls 110 have interior latches (not shown) to lock them into a fully vertical position.

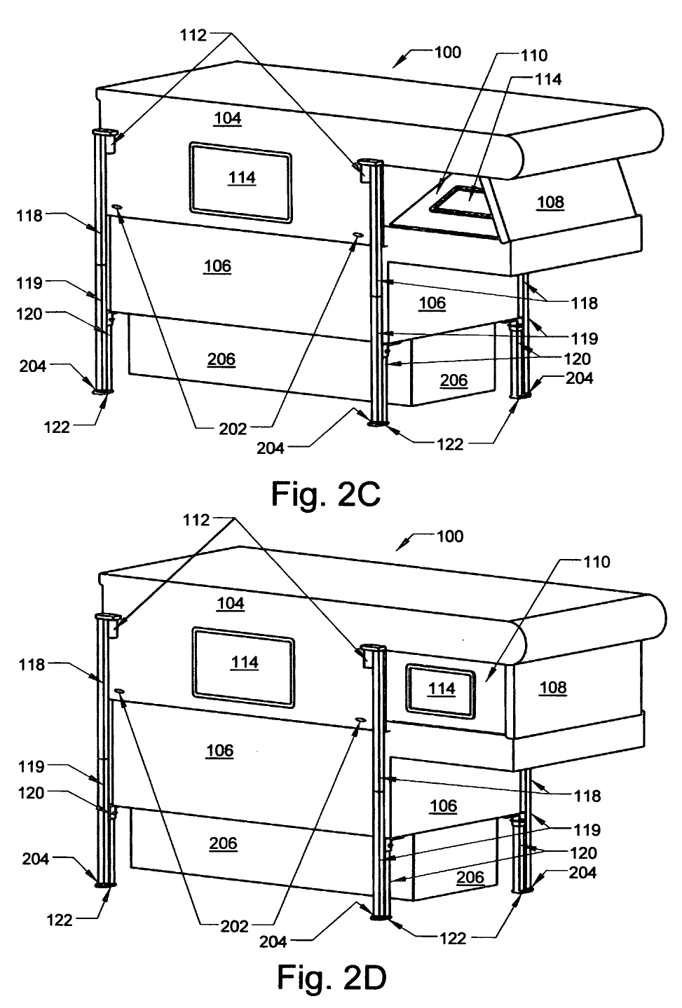

FIG. 3 is a perspective view of the preferred embodiment of the present invention depicting Telescoping Camper 100 removed from Truck 102, collapsed, and ready for storage. With Security Pins 202 locked in place and Jack Supports 120 removed, Jack Extensions 119 are lowered to the ground for raising Telescoping Camper 100 as a fixed unit onto or off of Truck 102.

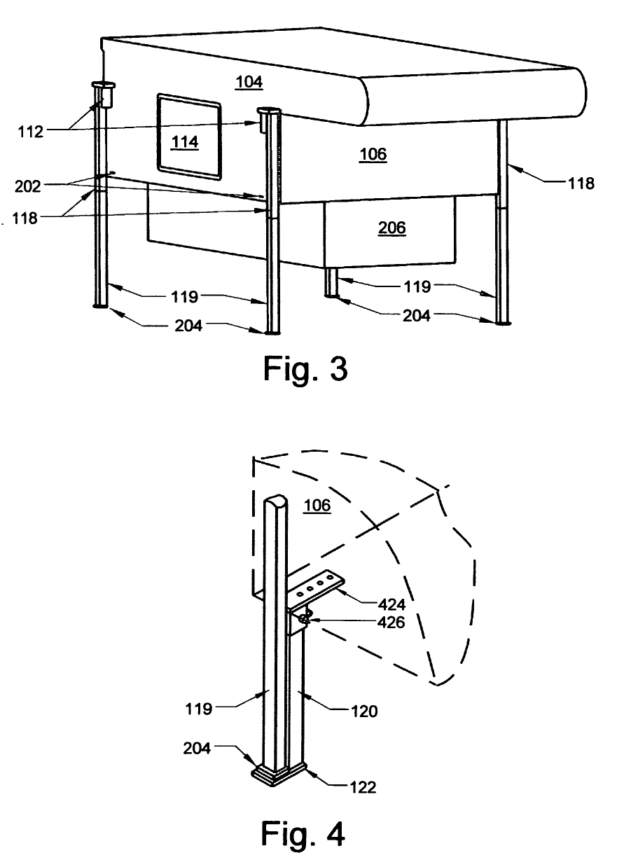

FIG. 4 is a detailed view of jacking system of the preferred embodiment of the present invention. Support Attachment Plate 424 is fixedly attached to Camper Lower Portion 106 (shown in phantom) by a series of screws or bolts. Jack Support 120 is attached to Support Attachment Plate 424 by Jack Support Pins 426. With Jack Support Pins 426 removed from Jack Supports 120 on each of the four corners of Camper Lower Portion 106, Jack Extensions 119 can be lowered to the ground and Telescoping Camper 100 is raised or lowered onto Truck 102. Jack Supports 120 can be stowed until needed again to raise or telescope Telescoping Camper 100.

With the present invention, the ability to easily remove and reattach Jack Supports 120 allows Telescoping Camper 100 to use a single jacking or lift mechanism for both raising Telescoping Camper 100 off Truck 102 and for raising/lowering or telescoping Camper Upper Portion 104. The multifunctional lift system of the present invention eliminates the need for a secondary lift system as is required by the prior art as well as simultaneously raises the folding walls in the over cab section of Telescoping Camper 100.

It has also been contemplated to have Jack Supports 120 pivotally attached to Camper Lower Portion 106, thereby allowing them to pivot out of the path of Jack Extensions 119 and eliminating the need to remove them to allow Jack Extensions 119 to extend to the ground.

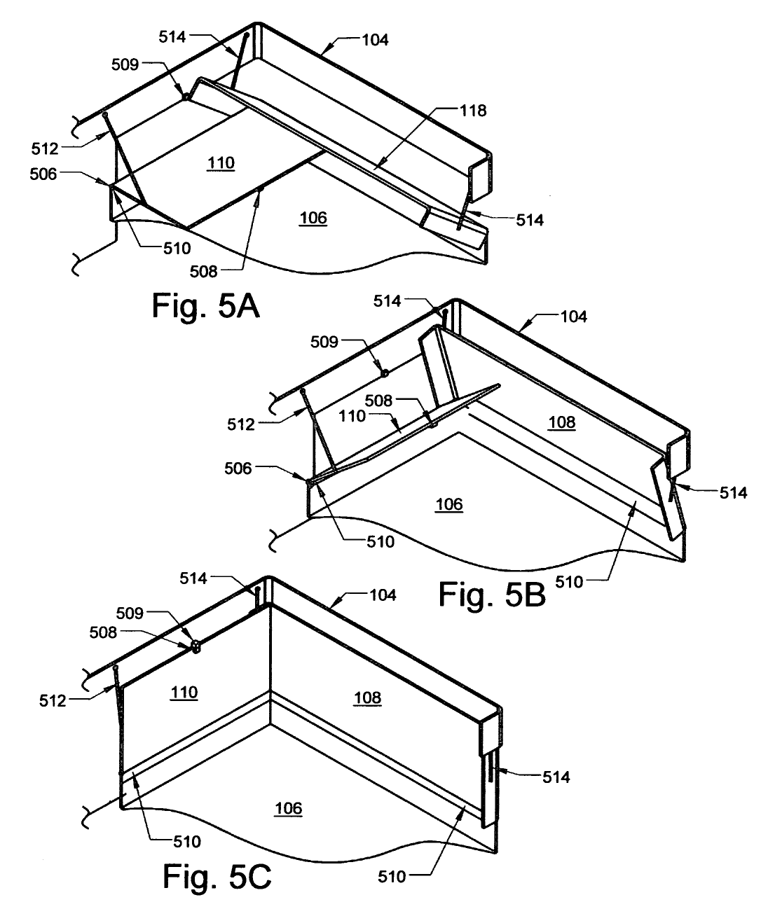

FIG. 5A through FIG. 5C is a series of perspective views of the folding walls of the present invention from the interior of Telescoping Camper 100.

In FIG. 5A, Folding Side Wall 110 and Folding Front Wall 108 are shown in the early stages of raising during the upward telescoping of Telescoping Camper 100. Folding Wall 110 has a pair of Side Wall Cables 512 with one end attached to either side of Folding Wall 100 and the other end attached to the interior of Camper Upper Portion 104. Similarly, Folding Front Wall 108 has a pair of Front Wall Cables 514 with one end attached to either side of Folding Front Wall 108 and the other end attached to the interior of Camper Upper Portion 104. There are three Collapsible Wall Hinges 506 that attach the lower edge of Folding Front Wall 108 (not shown) and both Folding Side Wall 110 to Camper Lower Portion 106. In the preferred embodiment, Collapsible Wall Hinges 506 are spring loaded hinges biased toward standing the collapsible walls in the vertical position. Alternately, they could be assisted with bungee style or elastic cords.

FIG. 5B depicts an intermediate stage in the lifting of Camper Upper Portion 104 with Folding Front Wall 108 nearly vertical and Folding Side Wall 110 approximately half way righted. As shown in FIG. 5B, Camper Upper Portion 104 is pulling Folding Side Wall 110 and Folding Front Wall 108 upward by Side Wall Cable 512 and Front Wall Cables 514, respectively.

FIG. 5C depicts an interior corner of Telescoping Camper 100 in the fully extended form. Both Folding Side Wall 100 and Folding Front Wall 108 are essentially vertical with Wall Latch 508 on Folding Side Wall 100 latched into Latch Catch 509 on Camper Upper Portion 104. As illustrated in FIG. 5C, the front edge of Folding Side Wall 100 rests against an edge of Folding Front Wall 108 holding it vertical without requiring a latch for Folding Front Wall 108. For both aesthetics and insulation, Hinge Cover 510 covers Collapsible Wall Hinges 506. In the preferred embodiment, Hinge Cover 510 is an insulated fabric, but can also be any fabric, carpet, or other covering that will hide Collapsible Wall Hinges 506.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

I claim:

1. A lift system for a telescoping camper, comprising:
a lower camper portion;
an upper camper portion having a front portion, said upper camper portion slidably attached around and over said lower camper portion;
at least two primary jacks attached to adjacent corners of said upper camper portion, each of said primary jacks having a lift mechanism fixedly attached to an upper end of said primary jacks and a jack extension in contact with said lift mechanism that telescopes from within said primary jacks by actuation of said lift mechanism, each of said jack extensions having a jack base disposed on a lower end of said jack extension; and
at least two jack supports removeably attached to said lower camper portion and adjacent to and essentially parallel to said primary jacks, said jack supports having a support platform attached to a base of said jack support;
wherein, said upper camper portion is raised above said lower camper portion by actuating said lift mechanism that extends said jack extensions simultaneously, said jack bases contacting and pushing upward from said support platforms until said upper camper portion is in a fully extended position, with said jack supports removed, actuating said lift mechanism further extends said jack extensions so said jack bases make contact and push against the ground to elevate the telescoping camper for removal from a truck.

2. The lift system for the telescoping camper of claim 1, further comprising:
a forward camper portion extending from said front portion of said upper camper portion and above said truck, said forward camper portion further comprising:
at least two collapsible side walls disposed on each of an opposing side of said forward camper portion, each of said collapsible side walls having a side wall base, a side wall hinge disposed along said side wall base and hingeably attached to said lower camper portion, and a side wall upper edge parallel to said side wall base;
a collapsible front wall having a front wall base, a front wall hinge disposed along said front wall base and hingeably attached to said lower camper portion; and
at least one lift cable attached at a first cable end to each of said collapsible side walls and to said collapsible front wall, and a second cable end opposite said first cable end attached to said upper camper portion,
wherein, as said upper camper portion is raised to said fully extended position, said lift cables pull said collapsible side walls and said collapsible front wall to an essentially vertical position, in said essentially vertical position said collapsible side walls are parallel to one another and perpendicular to said collapsible front wall.

3. The lift system for the telescoping camper of claim 2, further comprising:
at least one wall latch disposed on an upper edge of said folding side walls; and
at least one wall latch catch disposed on an edge of said upper camper portion;
wherein, said at least one wall latch is slidably latched into each of said wall latch catches thereby securing said folding side wall in said essentially vertical position.

4. The lift system for the telescoping camper of claim 2, further comprising:
a hinge cover disposed along a lower edge of each of said folding side walls and along a front lower edge of said folding front wall, wherein, said hinge covers disguise a seam created between said lower edge of each of said folding side walls and along said front lower edge of said folding front wall and said upper camper portion.

5. The lift system for the telescoping camper of claim 1, wherein said primary jacks are a standard camper jacks.

6. The lift system for the telescoping camper of claim 1, further comprising an upper limit switch and a lower limit switch disposed in said lower camper portion wherein said upper limit switch is actuated when the telescoping camper is fully extended, and said lower limit switch is actuated when the telescoping camper is fully retracted.

7. A lift system for a telescoping camper, comprising:
a lower camper portion;
an upper camper portion having a front portion, said upper camper portion slidably attached around and over said lower camper portion;
a primary jack attached to an outer corner of said upper camper portion, each of said primary jacks having a lift mechanism fixedly attached to an upper end of said primary jacks and a jack extension in contact with said lift mechanism that telescopes from within said primary jacks by actuation of said lift mechanism, each of said jack extensions having a jack base disposed on a lower end of said jack extension; and
a jack support rotatably attached to a second outer corner of said lower camper portion and adjacent to and essentially parallel to said primary jacks, said jack supports having a support platform attached to a base of said jack support;
wherein, said upper camper portion is raised above said lower camper portion by actuating said lift mechanism that extends said jack extensions simultaneously, said jack bases contacting and pushing upward from said support platforms until said upper camper portion is in a fully extended position, with said jack supports rotated away from said jack bases, actuating said lift mechanism further extends said jack extensions past said support platforms so said jack bases make contact and push against the ground to elevate the telescoping camper for removal from a truck.

8. The lift system for the telescoping camper of claim 7, further comprising:
a forward camper portion that extends from said front portion of said upper camper portion and above a cab portion of said truck, said forward camper portion further comprising:
at least two collapsible side walls disposed on each of an opposing side of said forward camper portion, each of said collapsible side walls having a side wall base, a side wall hinge disposed along said side wall base and hingeably attached to said lower camper portion, and a side wall upper edge parallel to said side wall base;
a collapsible front wall having a front wall base, a front wall hinge disposed along said front wall base and hingeably attached to said lower camper portion and a front wall upper edge parallel to said from wall base; and
at least one lift cable attached at a first cable end to each of said side wall upper edges and to said front wall upper edge, and a second cable end opposite said first cable end attached to said upper camper portion,
wherein, as said upper camper portion is raised to said fully extended position, said lift cables automatically pull said collapsible side walls and said collapsible front wall to an essentially vertical position, in said essentially vertical position said collapsible side walls are parallel to one another and perpendicular to said collapsible front wall.

9. The lift system or the telescoping camper of claim 8, further comprising:
at least one wall latch disposed on said upper side wall edge of; and
at least one wall latch catch disposed on said upper camper portion adjacent to said wall latch;
wherein, said at least one wall latch is slidably latched into each of said wall latch catches thereby securing said folding side wall in said essentially vertical position.

10. The lift system for the telescoping camper of claim 8, further comprising:
a hinge cover disposed along a lower edge of each of said folding side walls and along a front lower edge of said folding front wall, wherein, said hinge covers hide a seam created between said lower edge of each of said folding side walls and along said front lower edge of said folding front wall and said upper camper portion.

11. The lift system for the telescoping camper of claim 10, wherein the hinge cover is constructed of a length of carpet.

12. The lift system for the telescoping camper of claim 10, wherein the hinge cover is constructed of a length of fabric.

13. The lift system for the telescoping camper of claim 9, wherein said primary jacks are a standard camper jacks.

14. The lift system for the telescoping camper of claim 9, further comprising an upper limit switch and a lower limit switch disposed in said lower camper portion wherein said upper limit switch is actuated and thereby stops extension of said jack extension when the telescoping camper is fully extended, and said lower limit switch is actuated and thereby stops contraction of said jack extension when the telescoping camper is fully retracted.

15. A lift system for a telescoping camper for a truck having a lower camper portion and an upper camper portion having a front portion, said upper camper portion slidably attached around and over said lower camper portion, the telescoping having two rigid collapsible side walls and a rigid collapsible front wall in a portion of the telescoping camper over the cab of the truck, comprising;
a primary jack attached to an outer corner of said upper camper portion, each of said primary jacks having a lift mechanism fixedly attached to an upper end of said primary jacks and a jack extension in contact with said lift mechanism that telescopes from within said primary jacks by actuation of said lift mechanism, each of said jack extensions having a jack base disposed on a lower end of said jack extension; and
a jack support rotatably attached to a second outer corner of said lower camper portion and adjacent to and essentially parallel to said primary jacks, said jack supports having a support platform attached to a base of said jack support;
wherein, said upper camper portion is raised above said lower camper portion by actuating said lift mechanism that extends said jack extensions simultaneously, said jack bases contacting and pushing upward from said support platforms until said upper camper portion is in a fully extended position, the rigid collapsible side walls and the rigid collapsible front wall are hingeably attached to the lower camper portion extending over the truck cab and attached by a cable to the upper camper portion such that as the upper camper portion is telescoped upward, the right collapsible side walls and the rigid collapsible front wall are automatically righted to an essentially vertical position, and with said jack supports rotated away from said jack bases, actuating said lift mechanism further extends said jack extensions past said support platforms so said jack bases make contact and push against the ground to elevate the telescoping camper for removal from a truck.

16. The lift system for a telescoping camper of claim 15, wherein each said primary jack is a standard camper jack.

17. The lift system for a telescoping camper of claim 15, further comprising an upper limit switch and a lower limit switch disposed in the lower camper portion wherein said upper limit switch is actuated and thereby stops extension of said jack extension when the telescoping camper is fully extended, and said lower limit switch is actuated and thereby stops contraction of said jack extension when the telescoping camper is fully retracted.
